(19) United States
(12) Patent Application Publication
(10) Pub. No.: US 2008/0263432 A1
(43) Pub. Date: Oct. 23, 2008

(54) CONTEXT DEPENDENT PAGE RENDERING APPARATUS, SYSTEMS, AND METHODS

(75) Inventors: Adam Newcomb, Vista, CA (US); Joshua Bass, Carlsbad, CA (US); David Zimet, San Diego, CA (US); Dong Chen, La Jolla, CA (US); Jonathan McKinney, San Diego, CA (US)

Correspondence Address: SCHWEGMAN, LUNDBERG & WOESSNER, P.A., P.O. BOX 2938, MINNEAPOLIS, MN, 55402, US

(73) Assignee: ENTRIQ INC.

(21) Appl. No.: 11/738,262

(22) Filed: Apr. 20, 2007

(51) Int. Cl. G06F 17/00

(52) U.S. Cl. 715/200

(57) ABSTRACT

Apparatus, systems, and methods disclosed herein may receive one or more sets of presentation rendering property values (PRPVs) at a client processing device from a network device. A set of PRPVs may be associated with a set of presentation characteristics of a sensory output device (SOD) used to present a multimedia presentation, a state of the SOD, or a state of a filter used to filter the presentation. A subset of PRPVs may be associated with a presentation element. An operating system or other entity associated with the client processing device may be interrogated to determine a state of the SOD or of the filter. Using the subset of PRPVs, the presentation element may be rendered for presentation at the SOD with a set of predetermined perceptual characteristics compatible with the presentation characteristics associated with the SOD. Other embodiments may be described and claimed.

### TECHNICAL FIELD

Various embodiments described herein relate to apparatus, systems, and methods associated with multimedia processing and presentation, including multi-sensory presentation element rendering.

### BACKGROUND INFORMATION

Currently, multimedia content may be created and encoded specifically for an output device type or format anticipated by the content producer. For example, much Internet browser content is currently created for standard 4×3 aspect ratio computer monitor screens. Annoying black-bar margins may appear on the right and left-hand sides of the 4×3 content window when the standard Internet browser content is displayed on a 16×9 or similar wide-screen computer monitor or home theatre system. Likewise, 16×9 content may display on a 4×3 monitor with horizontal black bands at the top and bottom of the image. Or, if expanded vertically to fill the 4×3 screen, the 16×9 content may be cut off on the left and right-hand sides.

In another example, the multimedia content may be encoded with a color palette suitable for a flat screen display, to include pure blacks and pure whites. This encodation may be unsuitable for a National Television Systems Committee (NTSC)-limited monitor, and may even cause damage by exceeding raster power specifications.

### BRIEF DESCRIPTION OF THE DRAWINGS

FIG. 1 is an interface diagram of a prior art standard 4×3 aspect ratio presentation page showing various presentation elements.

FIG. 2 is an interface diagram of a prior art standard 4×3 aspect ratio presentation page as displayed on a 16×9 monitor.

FIG. 3 is an interface diagram of a 4×3 aspect ratio presentation page as adapted by various example embodiments of the invention.

FIG. 4 is a block diagram of an apparatus and a system according to various example embodiments of the invention.

FIG. 5 is a flow diagram illustrating several methods according to various example embodiments of the invention.

FIG. 6 is a block diagram of a computer readable medium (CRM) according to various embodiments.

### DETAILED DESCRIPTION

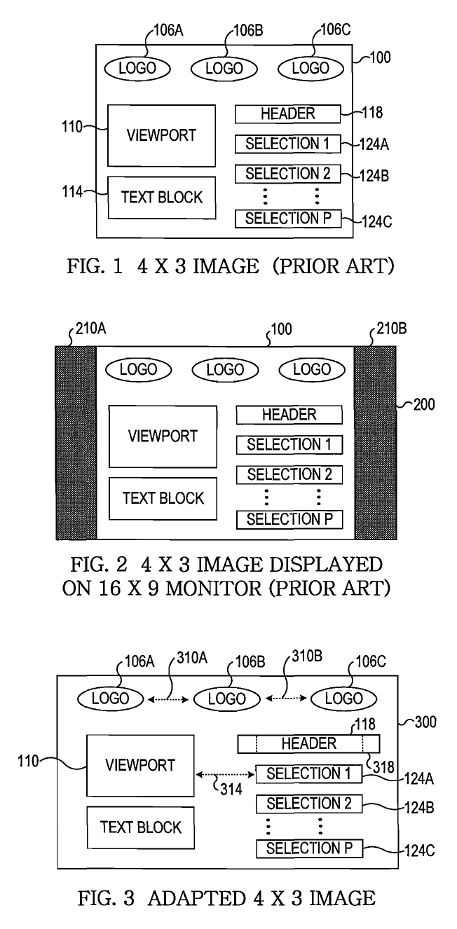

FIG. 1 is an interface diagram of a prior art standard 4×3 aspect ratio (AR) presentation page 100 showing various presentation elements of a multimedia presentation. “Multimedia presentation” as used herein means any presentation material capable of perception by a human sensory system, including visual, aural, tactile, olfactory, taste, or balance perception. The presentation elements may include one or more logos 106A, 106B, and 106C. Other elements may include a viewport 110, text block 114, text header element 118, and selection pushbuttons 124A, 124B, and 124C. The viewport 110 may frame a still image or a video sequence. The aforesaid presentation elements are merely examples. Other presentation elements may include radio buttons, sliders, bitmapped images, whether visually or tactilely perceived, text entry controls, text fillable fields, drag and drop controls, and others known to those skilled in the art. Additional presentation elements may include non-traditional material capable of tactile perception, olfactory perception, balance perception, or perception by taste.

Some elements may be passive and may not be subject to interaction with a user. Other elements may be active in that their appearance may change when clicked on, mouse hovered over, or otherwise chosen or indicated by the user. An active presentation element may also cause a programmatic state change in an application associated with the presentation, on a presented page, or in a sequence of presented pages. A presentation element may be located within a specified zone of a specified page of a multimedia presentation. “Page” as used herein means a subdivision or segment of the multimedia presentation generally.

FIG. 2 is an interface diagram of the prior art standard 4×3 AR presentation page 100 as displayed on a 16×9 AR monitor 200. To the annoyance of a viewer or audience of viewers, vertical black or white bands 210A and 210B may appear on the right and left-hand sides of the 16×9 AR monitor 200. The presentation page 100 may thus appear compressed and the 16×9 AR monitor 200 may appear underutilized. Some viewers may apply a “full screen” viewing function to the presentation page 100 to fill the bands 210A and 210B, resulting in cutoff portions of the top and bottom of the presentation page 100.

Embodiments herein may adapt a multimedia presentation to capabilities and states of output devices and presentation software on-the-fly as the presentation is presented. Multiple sets of presentation rendering property values (PRPVs) may be received at a client processing device for use in the adaptation process. A PRPV is a data representation of an attribute capable of application to a presentation element to cause a predetermined perceptual characteristic to manifest itself when the element is presented to an audience of one or more people. A PRPV may comprise a numerical value, an alphanumerical value, an algebraic formula, a biochemical formula, a matrix of numerical values, a spatial matrix of geometrical points, or any other form capable of representing the presentation attribute.

Individual sets of PRPVs may be maintained for each of several output devices used to present the multimedia presentation. A subset of PRPVs may be associated with each presentation element. In a simple example, a 4×3 AR set of PRPVs may be used by the client processing device to render the presentation page 100. So rendered, the 4×3 AR presentation page 100 may appear on the 16×9 AR monitor 200 as shown in FIG. 2.

FIG. 3 is an interface diagram of a 4×3 AR presentation page as adapted by various example embodiments of the invention. A 16×9 AR set of PRPVs may be used by the client processing device to render the presentation page 100 as the adapted presentation page 300. PRPVs associated with the logos 106A and 106C may, for example, establish relative locations of the logos 106A and 106C with respect to the logo 106B. 16×9 AR distancing PRPVs may declare larger values for relative separation distances between the logos 106A, 106C and the logo 106B than corresponding distancing PRPVs in the 4×3 AR PRPV set. Using the 16×9 set of PRPVs, the logos 106A and 106C may thus be rendered further distant from the logo 106B than with the 4×3 PRPV set, as shown by distances 310A and 310B of FIG. 3. A distance 314 between the viewport 110 and selection pushbuttons 124A, 124B, and 124C may likewise be set to a larger value when invoking the 16×9 AR PRPV set. Other presentation element attributes may be included in a PRPV set associated with a presentation element. For example, an attribute for a width of the header 118 may be set to a larger value in the 16×9 AR version of the header PRPV set than in the 4×3 AR version. An elongation 318 of the header 118 may be rendered as a result.

In another example, a non-NTSC instance of a PRPV for a white logo on a web page may be associated with a flat-screen monitor. The non-NTSC instance of the PRPV may associate a pure white color of maximum intensity with the logo. An NTSC instance of the PRPV may be associated with a cathode ray tube (CRT) version of the PRPV for the white logo. The NTSC instance of the PRPV may associate an off-white color of reduced intensity with the logo. Some embodiments may read operating system-supplied display attribute values to determine whether an attached display is NTSC-limited. If a display is determined to be so limited, the example logo may be presented using the NTSC instance of the white logo PRPV. Embodiments herein may thus apply PRPV attributes to individual presentation elements as appropriate for particular hardware and presentation software capabilities and states.

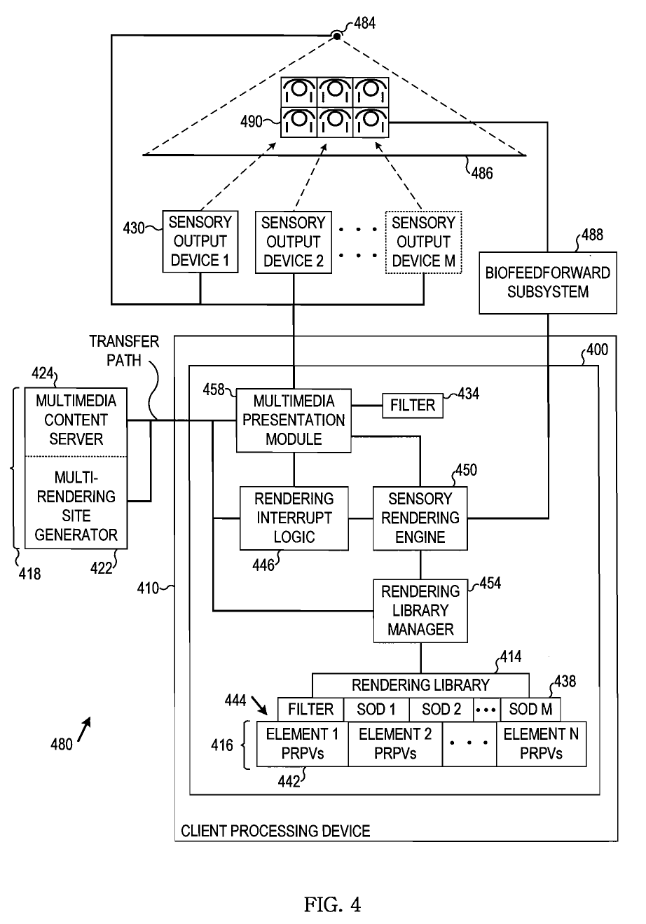

FIG. 4 is a block diagram of an apparatus 400 and a system 480 according to various example embodiments. The apparatus 400 may be included in a client processing device 410 used to present a multimedia presentation. The client processing device 410 may comprise a laptop computer, a desktop computer, a handheld computing device, a cellular telephone, a set-top box, a multimedia distribution center, or a gaming system, among other devices.

The apparatus 400 may include a rendering library 414. The rendering library 414 may receive one or more sets of PRPVs, perhaps from a network device 418. A set of PRPVs (hereinafter exemplified as “the set of PRPVs 416”) may comprise a set of cascading style sheets or a set of XForms. Cascading style sheets (CSS) is a stylesheet language used to describe the presentation of a document written in a markup language. Additional information regarding CSS may be found in Eric A. Meyer, Cascading Style Sheets: The Definitive Guide, 3^{rd} ed., ISBN 0596527330. Additional information regarding XForms may be found in various W3C publications, including “The Next Generation of Web Forms” found at http://www.w3.org/MarkUp/forms/.

The network device 418 may comprise a multi-rendering site generator 422. “Multi-rendering site generator” in this context means a website creation entity capable of creating website pages and multiple sets of PRPVs, the latter to be used in the rendering of the website pages at the client processing device 410. In some embodiments, the multi-rendering site generator 422 may comprise a multimedia content server 424.

A set of PRPVs 416 may be associated with one or more presentation characteristics associated with a sensory output device (SOD) (hereinafter exemplified as “the SOD 430”) used to present a multimedia presentation. The SOD 430 may comprise a video monitor, an electronic device with a built-in video display, a video projection imager, a television set, a holographic display apparatus, a tactile device, an audio device, an olfactory device, a taste sensation device, or a force feedback mechanism, among others.

SOD presentation characteristics may include a device type, an aspect ratio associated with a video display device, a resolution associated with a video display device, a color space parameter associated with a video display device, whether a video display device is limited to a set of NTSC-specified colors, a three-dimensional rendering format associated with a video display device, a multi-channel format associated with an audio device, and whether an audio channel is enabled in an audio device, among others. In some embodiments, a SOD presentation characteristic may include less-traditional characteristics, including a tactile sensation format associated with a tactile output device, an olfactory sensation format associated with an olfactory stimulation device, a taste sensation format associated with a taste sensation stimulation device, or a force sensation format associated with a force feedback apparatus.

A set of PRPVs may also be associated with a state of the SOD 430. A state of the SOD 430 may comprise one or more of an on or off state, whether a particular sensory channel is currently enabled in a multi-sensory SOD, a current availability of a SOD presentation characteristic, or a current level setting associated with a presentation characteristic. A level setting may comprise an amplitude setting, a frequency setting, or a sensitivity setting, among other levels. Thus, a level setting may comprise a digital value representative of a weight of a presentation characteristic.

In the case of a monitor with built-in speakers for example, the speakers may be off. In that case, a set of PRPVs may be invoked in response to sensing the “speaker off” state to disable audio, enable closed captioning, and decrease visual element sizes to make room on a presentation page for the closed captioning elements. The latter case is merely an example. Other PRPVs may be invoked in response to the speaker off state, including declaratives that result in other predetermined perceptual characteristics.

Consider a further example using audio presentation characteristics. Volume may be independently controlled for each of five channels associated with a multi-channel sound system. Embodiments herein may sense the active presence of the multi-channel sound system and a low volume setting of the right-rear channel. In response, one or more PRPVs may be invoked to feed right-rear audio information to the left-rear channel to assure perception of the right-rear audio information. If during the presentation the right-rear volume is adjusted upward by the user, PRPVs may be invoked to discontinue the feed of the right-rear audio information to the left-rear channel. Embodiments herein may thus dynamically sense the state of the SOD 430 and responsively invoke PRPVs accordingly, as described further below.

A set of PRPVs may also be associated with a state of a filter 434 used to filter the multimedia presentation prior to passing the presentation to the SOD 430. The filter 434 may comprise a digital filter, an analog filter, or any other filter to selectively act upon a portion of the multimedia presentation in a predetermined way. The filter 434 may also comprise a visual filter including a module to perform a windowing function. The windowing function may filter a presentation by manipulating a window size or aspect ratio as presented to a video display device. A set of 16×9 aspect ratio PRPVs may be invoked when the presentation window is manipulated to an aspect ratio that is closer to 16×9 than 4×3, for example. Likewise, a set of 4×3 aspect ratio PRPVs may be invoked when the presentation window is manipulated to an aspect ratio closer to 4×3 than to 16×9. These aspect ratios are merely examples, selected for purposes of illustration because they are commonly found in existing monitors and wide-screen television sets.

Thus the set of PRPVs 416 may be associated with one or more presentation characteristics associated with the SOD 430, a state of the SOD 430, or the filter 434. In some embodiments, a corresponding division 438 of the rendering library may correspond to the set of PRPVs 416 associated with particular presentation characteristics, SOD state, or filter 434 preceding the SOD. Likewise, a subset of the set of PRPVs 416 (exemplified hereinafter as “the subset of PRPVs 442”) may be associated with a multimedia presentation element. A sub-division 444 of the rendering library may correspond to the subset of PRPVs 442, and may be organized by presentation element. Other rendering library organizational formats are comprehended herein.

The apparatus 400 may also include rendering interrupt logic 446 operatively coupled to the rendering library 414. The rendering interrupt logic 446 may respond to a rendering event by identifying a state of the SOD 430 or a state of the filter 434 preceding the SOD 430. In some embodiments, the rendering interrupt logic 446 may interrogate another portion of the client processing device 410, including the operating system, to determine these states.

The apparatus 400 may further include a sensory rendering engine 450 coupled to the rendering interrupt logic 446. The sensory rendering engine may execute JavaScript® code, ActionScript® code, or like executable structures. The sensory rendering engine 450 may render a presentation element using the subset of PRPVs 442. The presentation element may be rendered such that the element is capable of presentation at the SOD 430 with a set of predetermined perceptual characteristics compatible with the presentation characteristics.

A predetermined perceptual characteristic as used herein may include a color, a size, a shape, a tactile pattern, an audio filter characteristic, a smell, a taste, a position relative to a presentation frame, a position relative to at least one other presentation element, a presence or absence of the element, or a behavior associated with the element, among others. Thus, individual PRPVs may be associated with the predetermined perceptual characteristics. Embodiments herein may use an individual PRPV to adjust a parameter associated with a presentation characteristic to render a presentation element according to a predetermined perceptual characteristic.

Behaviors associated with a presentation element may include transitions or rates of transitions from a first attribute to a second attribute. A transition from a first color to a second color, from a first size to a second size, from a first shape to a second shape, from a first tactile pattern to a second tactile pattern, from a first audio filter characteristic to a second audio filter characteristic, from a first smell to a second smell, from a first taste to a second taste, from a first position relative to a presentation frame to a second position relative to the presentation frame, from a first position relative to one or more other presentation elements to a second position relative to the one or more other presentation elements, or from a first presence or absence of the element to a second presence or absence of the element are examples of transitions that may be comprehended by embodiments herein.

The apparatus 400 may also include a rendering library manager 454 coupled to the rendering library 414. The rendering library manager 454 may download additional PRPVs from the multi-rendering site generator 422 in response to additional rendering events. Alternatively, a full library of PRPVs may be pre-downloaded in order to enable local access to additional PRPVs used to respond to the additional rendering events.

The apparatus 400 may further include a multimedia presentation module 458 coupled to the sensory rendering engine 450 and to the filter 434. In some embodiments, the multimedia presentation module 458 may comprise an Internet web browser or a multimedia-centric operating system. The multimedia presentation module 458 may compose a presentation page comprising one or more elements as rendered by the sensory rendering engine 450, and may display the presentation page on the SOD 430.

In another embodiment, a system 480 may include one or more of the apparatus 400, including a rendering library 414, rendering interrupt logic 446, and a sensory rendering engine 450. That is, the apparatus 400 may be incorporated into the system 480 as a hardware, firmware, or software component, for example. The system 480 may also include a theatre projector 484 operatively coupled to the multimedia presentation module 458. The theatre projector 484 may project images associated with the multimedia presentation onto a viewing screen 486.

The system 480 may further include a biofeedforward subsystem 488 coupled to the sensory rendering engine 450. The biofeedforward subsystem 488 may sense one or more physiological responses from one or more audience participants 490. Such physiological responses may include blood pressure, heart rate, skin temperature, galvanic skin response, a muscle tension indication, or an electroencephalograpic waveform. The biofeedforward subsystem 488 may present indications of the physiological responses to the sensory rendering engine 450. The sensory rendering engine 450 may use the physiological responses as inputs to the rendering of one or more presentation elements at a SOD 430. Such biofeedforward loops may be used to increase or decrease levels of excitement associated with the presentation.

Any of the components previously described may be implemented in a number of ways, including embodiments in software. Software embodiments may be used in a simulation system, and the output of such a system may provide operational parameters to be used by the various apparatus described herein.

Thus, the presentation pages 100, 300; the logos 106A, 106B, and 106C; the viewport 110; the text block 114; the text header element 118; the pushbuttons 124A, 124B, and 124C; the monitor 200; the bands 210A, 210B; the distances 310A, 310B, 314; the elongation 318; the apparatus 400; the client processing device 410; the rendering library 414; the network device 418; the set of PRPVs 416; the multi-rendering site generator 422; the multimedia content server 424; the SOD 430; the filter 434; the division 438; the subset of PRPVs 442; the sub-division 444; the rendering interrupt logic 446; the sensory rendering engine 450; the rendering library manager 454; the multimedia presentation module 458; the system 480; the theatre projector 484; the viewing screen 486; the biofeedforward subsystem 488; and the audience participants 490 may all be characterized as “modules” herein.

The modules may include hardware circuitry, optical components, single or multi-processor circuits, memory circuits, software program modules and objects, firmware, and combinations thereof, as desired by the architect of the apparatus 400 and the system 480 and as appropriate for particular implementations of various embodiments.

The apparatus and systems of various embodiments may be useful in applications other than adapting a multimedia presentation to capabilities and states of output devices and presentation software on-the-fly as the presentation is presented. Thus, various embodiments of the invention are not to be so limited. The illustrations of the apparatus 400 and of the system 480 are intended to provide a general understanding of the structure of various embodiments. They are not intended to serve as a complete or otherwise limiting description of all the elements and features of apparatus and systems that might make use of the structures described herein.

The novel apparatus and systems of various example embodiments may comprise and/or be included in electronic circuitry used in computers, communication and signal processing circuitry, single-processor or multi-processor modules, single or multiple embedded processors, multi-core processors, data switches, and application-specific modules including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., Motion Picture Experts Group (MPEG) Audio Layer 3 (MP3) players), vehicles, medical devices (e.g., heart monitor, blood pressure monitor, etc.), set top boxes, and others. Some embodiments may include a number of methods.

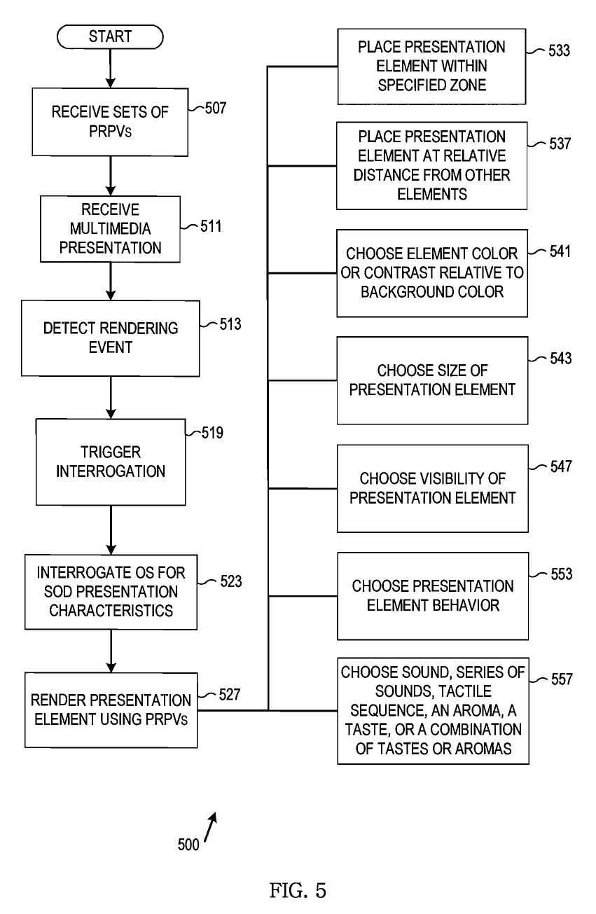

FIG. 5 is a flow diagram illustrating several methods according to various example embodiments of the invention. A method 500 may commence at block 507 with receiving one or more sets of PRPVs at a client processing device. Turning back to FIG. 4, for example, the set of PRPVs 416 may be received at the client processing device 410. The PRPVs may be received from a network device including a network server, or from some other data source, including a CD ROM or other data storage device. The PRPVs may be delivered via TCP/IP transport, shared memory interprocess communication, or named pipes, for example.

A set of PRPVs may be associated with a set of presentation characteristics of a SOD such as a video monitor, a video projection imager, a television set, a holographic display device, a tactile device, an audio device, an olfactory device, a taste sensation device, a force feedback apparatus, or other output device used to present a multimedia presentation.

The presentation characteristics may include a device type, an aspect ratio associated with a video display device, a resolution associated with the video display device, a color space parameter associated with the video display device, whether the video display device is limited to a set of NTSC-specified colors, a three-dimensional rendering format associated with the video display device, a multi-channel format associated with an audio device, and whether an audio channel is enabled in the audio device, among others. In some embodiments, the presentation characteristics may include less-traditional characteristics, including a tactile sensation format associated with a tactile output device, an olfactory sensation format associated with an olfactory stimulation device, a taste sensation format associated with a taste sensation stimulation device, and/or a force sensation format associated with a force feedback apparatus.

A set of PRPVs may also be associated with a state of the SOD or with a state of a filter used to filter the multimedia presentation. A subset of the set of PRPVs may be associated with a presentation element.

The method 500 may continue at block 511 with receiving the multimedia presentation as one or more data files from a multimedia content server, or from some other data source.

The method 500 may also include detecting a rendering event associated with a presentation of multimedia content, at block 513. A rendering event in this context may include a composition of a presentation page, a transition to a new page, or an occurrence of a windowing event, as previously described. The rendering event may trigger an interrogation of the operating system associated with the client processing device, at block 519. Through the interrogation of the operating system or otherwise, the method 500 may further include determining a state of the SOD or of the filter preceding the SOD, at block 523.

The method 500 may continue at block 527 with rendering the presentation element using the subset of PRPVs. The presentation element may be rendered such that the element is capable of presentation at the SOD with a set of predetermined perceptual characteristics. The predetermined perceptual characteristics may correspond to the presentation characteristics associated with the SOD, and may include a color, a size, a shape, a tactile pattern, an audio filter characteristic, a smell, a taste, a position relative to a presentation frame, a position relative to at least one other presentation element, a presence or absence of the element, or a behavior associated with the element.

One or more PRPVs may cause the presentation element to be placed within a specified zone of a page of the multimedia presentation, at block 533 or to be placed at a relative distance from other presentation elements on a page of the multimedia presentation, at block 537. The PRPVs may also cause a color of the presentation element or a contrast of the presentation element relative to a background brightness to be chosen, at block 541. The PRPVs may further cause a sizing of the presentation element, at block 543.

The PRPVs may result in a choice of whether the presentation element is visible, at block 547. The PRPVs may also invoke a choice of a behavior associated with the presentation element, at block 553. Behaviors may include transitions or rates of transitions from a first attribute to a second attribute and may include a transition from a first color to a second color, from a first size to a second size, etc., as previously described. The PRPVs may further invoke a choice of a sound, a series of sounds, a tactile sequence, an aroma, a combination of aromas, a taste, or a combination of tastes associated with the presentation element, at block 557.

It may be possible to execute the activities described herein in an order other than the order described. Various activities described with respect to the methods identified herein may be executed in repetitive, serial, or parallel fashion, or a combination thereof.

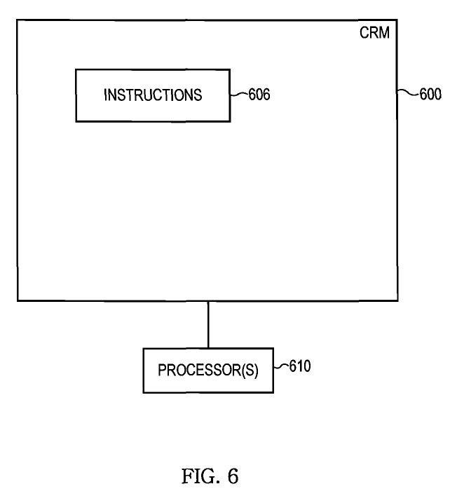

A software program may be launched from a CRM in a computer-based system to execute functions defined in the software program. Various programming languages may be employed to create software programs designed to implement and perform the methods disclosed herein. The programs may be structured in an object-oriented format using an object-oriented language such as Java or C++. Alternatively, the programs may be structured in a procedure-oriented format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment. Thus, other embodiments may be realized, as discussed regarding FIG. 6 below.

FIG. 6 is a block diagram of a CRM 600 according to various embodiments of the invention. Examples of such embodiments may comprise a memory system, a magnetic or optical disk, or some other storage device. The CRM 600 may contain instructions 606 which, when accessed, result in one or more processors 610 performing any of the activities previously described, including those discussed with respect to the method 500 noted above.

The apparatus, systems, and methods disclosed herein may enable higher levels of multimedia content abstraction at the production and distribution stages by adapting a multimedia presentation to capabilities and states of output devices and presentation software on-the-fly as the content is presented. Cost efficiencies and an enhanced user experience may be realized thereby.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims and the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, comprising:
a rendering library at a client processing device to receive a set of presentation rendering property values (PRPVs) associated with at least one of a set of presentation characteristics of a sensory output device (SOD) used to present a multimedia presentation, a state of the SOD, or a state of a filter used to filter the multimedia presentation;
an area of the rendering library to contain a subset of the set of PRPVs associated with a multimedia presentation element;
rendering interrupt logic communicatively coupled to the rendering library to respond to a rendering event by determining at least one of the state of the SOD or the state of the filter; and
a sensory rendering engine communicatively coupled to the rendering interrupt logic to render the presentation element using the subset of PRPVs such that the presentation element is capable of presentation at the SOD with a set of predetermined perceptual characteristics compatible with the set of presentation characteristics.

2. The apparatus of claim 1, wherein the rendering library is adapted to receive the set of PRPVs from a network device.

3. The apparatus of claim 1, wherein the set of PRPVs comprises at least one of a set of cascading style sheets or a set of XForms.

4. The apparatus of claim 1, wherein the sensory rendering engine comprises at least one of JavaScript® code or ActionScript® code.

5. The apparatus of claim 1, wherein the network device comprises a multi-rendering site generator.

6. The apparatus of claim 5, wherein the multi-rendering site generator comprises a multimedia content server.

7. The apparatus of claim 1, wherein the client processing device comprises at least one of a laptop computer, a desktop computer, a handheld computing device, a cellular telephone, a set-top box, a multimedia distribution center, or a gaming system.

8. The apparatus of claim 1, wherein the SOD comprises at least one of a video monitor, an electronic device with a built-in video display, a television set, a holographic display device, a tactile device, an audio device, an olfactory device, a taste sensation device, or a force feedback apparatus.

9. The apparatus of claim 1, wherein the filter comprises at least one of a digital filter, an analog filter, or a windowing function.

10. The apparatus of claim 1, wherein the at least one presentation characteristic associated with the SOD comprises at least one of a device type, an aspect ratio associated with a video display device, a resolution associated with the video display device, a color space parameter associated with the video display device, whether the video display device is limited to a set of NTSC-specified colors, a three-dimensional rendering format associated with the video display device, a multi-channel format associated with an audio device, whether an audio channel is enabled in the audio device, a tactile sensation format associated with a tactile output device, an olfactory sensation format associated with an olfactory stimulation device, a taste sensation format associated with a taste sensation stimulation device, or a force sensation format associated with a force feedback device.

11. The apparatus of claim 1, wherein the state of the SOD comprises at least one of an on state or an off state, whether a selected sensory channel is currently enabled in a multi-sensory SOD, a current availability of a presentation characteristic selected from the set of presentation characteristics, or a current level setting associated with the presentation characteristic.

12. The apparatus of claim 11, wherein the level setting comprises at least one of an amplitude setting, a frequency setting, or a sensitivity setting.

13. The apparatus of claim 1, wherein the presentation element comprises at least one of a logo, a header, a block of text, an action pushbutton, a radio button, a slider, a text entry control, a drag-and-drop control, a bitmapped image, or a video viewport contents.

14. The apparatus of claim 1, wherein the presentation element is located on a specified page of the multimedia presentation.

15. The apparatus of claim 1, wherein the presentation element is located within a specified zone of a page of the multimedia presentation.

16. The apparatus of claim 1, wherein the predetermined perceptual characteristic comprises at least one of a color, a size, a shape, a tactile pattern, an audio filter characteristic, a smell, a taste, a position relative to a presentation frame, a position relative to at least one other presentation element, a presence or absence of the element, or a behavior associated with the element.

17. The apparatus of claim 16, wherein the behavior associated with the element comprises a change from at least one of a first color to a second color, a first size to a second size, a first shape to a second shape, a first tactile pattern to a second tactile pattern, a first audio filter characteristic to a second audio filter characteristic, a first smell to a second smell, a first taste to a second taste, a first position relative to the presentation frame to a second position relative to the presentation frame, a first position relative to the at least one other presentation element to a second position relative to the at least one other presentation element, or a first presence or absence of the element to a second presence or absence of the element.

18. The apparatus of claim 16, wherein the behavior associated with the element comprises a rate of change from at least one of a first color to a second color, a first size to a second size, a first shape to a second shape, a first tactile pattern to a second tactile pattern, a first audio filter characteristic to a second audio filter characteristic, a first smell to a second smell, a first taste to a second taste, a first position relative to the presentation frame to a second position relative to the presentation frame, a first position relative to the at least one other presentation element to a second position relative to the at least one other presentation element, or a first presence or absence of the element to a second presence or absence of the element.

19. The apparatus of claim 1, further including:
a rendering library manager coupled to the rendering library to download additional PRPVs from the network device in response to additional rendering events.

20. The apparatus of claim 1, further including:
a division of the rendering library corresponding to the set of PRPVs, the division organized by SOD; and
a sub-division of the rendering library corresponding to the subset of PRPVs, the sub-division organized by presentation element.

21. The apparatus of claim 1, further including:
a multimedia presentation module coupled to the sensory rendering engine to compose a presentation page comprising at least one element as rendered by the sensory rendering engine and to display the presentation page on the SOD.

22. The apparatus of claim 21, wherein the multimedia presentation module comprises at least one of an Internet web browser or a multimedia-centric operating system.

23. A system, comprising:
a rendering library at a client processing device to receive a set of presentation rendering property values (PRPVs) associated with at least one of a set of presentation characteristics of a sensory output device (SOD) used to present a multimedia presentation, a state of the SOD, or a state of a filter used to filter the multimedia presentation;
an area of the rendering library to contain a subset of the set of PRPVs associated with a multimedia presentation element;
rendering interrupt logic communicatively coupled to the rendering library to respond to a rendering event by determining at least one of the state of the SOD or the state of the filter; and
a sensory rendering engine communicatively coupled to the rendering interrupt logic to render the presentation element using the subset of PRPVs such that the presentation element is capable of presentation at the SOD with a set of predetermined perceptual characteristics compatible with the set of presentation characteristics; and
a biofeedforward subsystem coupled to the sensory rendering engine to sense a physiological response from at least one audience participant in the multimedia presentation and to present an indication of the physiological response to the sensory rendering engine to use as an input to the rendering of the presentation element.

24. The system of claim 23, wherein the SOD comprises at least one of a video monitor, a video projection imager, a holographic display device, a holographic projection device, a tactile device, an audio device, an olfactory device, a taste sensation device, or a force feedback mechanism.

25. The system of claim 23, further including:
a theatre projector to project images associated with the multimedia presentation onto a viewing screen.

26. The system of claim 23, wherein the physiological response comprises at least one of a blood pressure, a heart rate, a skin temperature, a galvanic skin response, a muscle tension indication, or an electroencephalograpic waveform.

27. A method, comprising:
at a client processing device, receiving a set of presentation rendering property values (PRPVs) associated with at least one of a set of presentation characteristics of a sensory output device (SOD) used to present a multimedia presentation, a state of the SOD, or a state of a filter used to filter the multimedia presentation;
associating a subset of the set of PRPVs with a multimedia presentation element;
determining at least one of the state of the SOD or the state of the filter; and
rendering the presentation element using the subset of the set of PRPVs such that the presentation element is capable of presentation at the SOD with a set of predetermined perceptual characteristics compatible with the set of presentation characteristics.

28. The method of claim 27, further including:
configuring the rendering library to receive the set of PRPVs from a network device.

29. The method of claim 27, further including:
placing the presentation element within a specified zone of a page of the multimedia presentation.

30. The method of claim 27, further including:
placing the presentation element at a relative distance from other presentation elements on a page of the multimedia presentation.

31. The method of claim 27, further including:
choosing at least one of a color of the presentation element or a contrast of the presentation element relative to a background brightness.

32. The method of claim 27, further including:
choosing a size of the presentation element.

33. The method of claim 27, further including:
choosing whether or not the presentation element is visible.

34. The method of claim 27, further including:
choosing a behavior associated with the presentation element.

35. The method of claim 27, further including:
choosing at least one of a sound, a series of sounds, a tactile sequence, an aroma, a combination of aromas, a taste, or a combination of tastes associated with the presentation element.

36. The method of claim 27, further comprising:
receiving the multimedia presentation as at least one data file from a multimedia content server.

37. The method of claim 27, further comprising:
detecting a rendering event associated with a presentation of multimedia content, wherein the rendering event comprises at least one of composing a presentation page, transitioning to a new page, or an occurrence of a windowing event; and
triggering an interrogation of the operating system upon detecting the rendering event.

38. A computer-readable medium having instructions, wherein the instructions, when executed, result in at least one processor performing:
at a client processing device, receiving a set of presentation rendering property values (PRPVs) associated with at least one of a set of presentation characteristics of a sensory output device (SOD) used to present a multimedia presentation, a state of the SOD, or a state of a filter used to filter the multimedia presentation;
associating a subset of the set of PRPVs with a multimedia presentation element;
determining at least one of the state of the SOD or the state of the filter; and
rendering the presentation element using the subset of the set of PRPVs such that the presentation element is capable of presentation at the SOD with a set of predetermined perceptual characteristics compatible with the set of presentation characteristics.
